(19) United States
(12) Patent Application Publication
(10) Pub. No.: US 2023/0046478 A1
(43) Pub. Date: Feb. 16, 2023

(54) Method and Device for Determining a Definite Distance

(71) Applicant: Siemens Aktiengesellschaft, Muenchen (DE)

(72) Inventors: Reinhard HLADIK, Wien (AT); Lennart KILIAN, Gauting (DE); Joachim WAHRBICHLER, Graz (AT); Corina Kim SCHINDHELM, Gröbenzell (DE); Ulrike GLÄNZER, Neubiberg (DE); Guido SCHRÖER, München (DE); Stefan SCHWARZER, Nürnberg (DE)

(21) Appl. No.: 17/784,332

(22) PCT Filed: Dec. 4, 2020
(86) PCT No.: PCT/EP2020/084637

§ 371 Date: Jun. 10, 2022

(30) Foreign Application Priority Data
Dec. 12, 2019 (EP) 19215728.7

(51) Int. Cl. G01S 11/02; H04W 4/02; H04W 12/61; H04W 12/104

(52) U.S. Cl. CPC G01S 11/02; H04W 4/023; H04W 12/61; H04W 12/104; H04L 1/0061

(57) ABSTRACT

A method for determining a definite safe distance between a wirelessly communicating object transponder and at least one anchor gateway in accordance with a two-way ranging method, wherein transmission and reception timestamps are detected for each communication message via the transponder and the at least one anchor gateway, each of the timestamps from the transponder and the at least one anchor gateway together with at least one respective piece of timestamp monitoring information are transmitted to a failsafe computing device, at least one check is implemented via the failsafe computing device, and the definite safe distance is determined via the failsafe computing device aided by the checked timestamps, where timestamp errors occurring during the detection of the timestamps are caused solely by the transponder or alternatively solely the one anchor gateway.

### CROSS-REFERENCE TO RELATED APPLICATIONS

This is a U.S. national stage of application No. PCT/EP2020/084637 filed 4 Dec. 2020. Priority is claimed on European Application No. 19215728.7 filed 12 Dec. 2019, the content of which is incorporated herein by reference in its entirety.

### BACKGROUND OF THE INVENTION

### 1. Field of the Invention

The invention relates to a method and a device for determining a definite safe distance between a wirelessly communicating object transponder and at least one anchor gateway, each of which having detectors for detecting timestamps, in accordance with a two-way ranging method.

### 2. Description of the Related Art

In production systems, protective fences are often employed to assure personal protection in order, for example, to protect operating personnel or moving objects from a moving assembly robot arm that is in operation.

However, protective fences require space in the production plant and can make accessing plant and equipment more difficult. This is indirectly associated with production costs, which have an undesirable negative impact on the cost-effective operation of a production system.

A virtual protective fence for dangerous production machines can be realized, for example, using a laser rangefinder measurement or visual detection via cameras, although generally this is very complicated, inflexible and expensive.

However, localizing a wirelessly communicating object transponder, i.e., calculating an absolute position in space (2D or 3D) via a radio-based localization system equipped with standard components, is considered unsafe and unreliable in the prior art.

The calculated position can be corrupted due to hardware faults and/or software errors in the components being used or as a result of physical effects which can be caused by the radio channel, for example.

Such effects can be caused by radio channels that are not based on a direct line-of-sight connection. Signal reflections can lead to multipath propagation and subsequently to multiple reception of the same transmit signal, though with different travel times or propagation delays.

An improvement in propagation delay measurement can be achieved via the well-known two-way ranging (TWR) method. The TWR method determines the signal propagation delay (time-of-flight) of the Ultra-wideband (UWB) RF signal and then calculates the distance between the nodes by multiplying the time by the speed of light. The TWR process is applied between a transponder and a requested anchor (also referred to as an anchor gateway or anchor transponder), in which case only one anchor should be involved in the TWR at any particular point in time.

An anchor is understood to mean a stationary radio unit whose position is known.

US publication 2009/310585 A1 describes a method that is based on the known TOA method and is used for determining a safety zone around a wirelessly communicating transceiver.

US publication 2014/038637 A1 discloses a method for determining a safety zone around a wirelessly communicating transceiver.

However, in both cited methods the determined position data of the transceiver cannot be used for safety-related systems because the conventional computing device used does not satisfy the high requirements in respect of data security.

In the publication “Information technology—Real time locating systems (RTLS)—Part 62: High rate pulse repetition frequency Ultra Wide Band (UWB) air interface”, ISO/IEC 24730-62:2013, IEC, 3, RUE DE VAREMBE, PO BOX 131, CH-1211 GENEVA 20, SWITZERLAND, Aug. 26, 2013 (2013-08-26), pages 1-57, XP082006036, a method is described where at least one anchor-to-object distance between a wirelessly communicating transponder and an infrastructure node at a known position is determined in accordance with the TWR principle via a distance measuring device that only secures the data transmission against errors.

However, only errors in the transmission of timestamps can be detected via this method and no failsafe approach that is suitable for safety applications is provided for determining a definite true position.

The publication CN 108 834 071 A describes a method for localization of wireless and wire-bound messages based on the integration of TOF and TDOA, where only the TOA has to be recorded and the synchronization calculation of the TOA can be concluded, and the time synchronization between base stations does not have to be carried out.

U.S. Pat. No. 8,325,704 B1 discloses a correction of a reception time of a data packet. A high-frequency input is converted into a data output signal. From the data output signal, a data clock pulse is recovered. Between the data output signal and the data clock pulse, a phase offset is measured. A reception time is corrected at least partially based on a timestamp that is a sampled value of a counter at the point in time of receiving a data packet and the phase offset. The time correction can be used to calculate a distance estimation.

US publication 2006/160540 A1 describes a method for determining the mobility of a node in a wireless communication network. The system and the method determine the distance between the node and at least one stationary neighboring node at at least two or more points in time using at least two moving average filters, in order to obtain two distance values. The system and the method then determine the relative velocity based on the at least two distance values and thus determine whether the node is mobile.

The publication HAKYONG KIM: “A ranging scheme for asynchronous location positioning systems”, POSITIONING, NAVIGATION AND COMMUNICATION, 2009. WPNC 2009. 6TH WORKSHOP ON, IEEE, PISCATAWAY, N.J., USA, Mar. 19, 2009 (2009 Mar. 19), pages 89-94, XP031452377, DOI: 10.1109/WPNC.2009.4907809, ISBN: 978-1-4244-3292-9 describes an asynchronous two-way ranging scheme that reduces ranging time by replying with multiple packets to a single ranging request. The algorithm reduces ranging time by 17% or more, compared to that of existing methods.

US publication 2013/286960 A1 discloses a base station that is configured to perform a coordinated transmission to at least one user device.

None of the described methods relate to a reliable, definite safe determination of positions of object transponders, in order to correspond to applications which are based on personal protection.

Thus, no locating method based on the use of a radio system is currently known via which safety-related tasks, such as dispensing with the use of protective fences in production plants, can be realized because the determination of the transmission parameters of a radio channel in particular is not sufficiently reliable in order to be used, for example, in a production system and in the event of an undesired intervention to shut down the production system and thereby to ensure the safety of persons and/or objects.

### SUMMARY OF THE INVENTION

In view of the foregoing, it is therefore an object of the invention to provide a method and a device for determining a failsafe distance between a wirelessly communicating object transponder and an anchor gateway while at the same time assuring high system availability.

In this case, the wirelessly communicating object transponder may be worn, for example, by a person, i.e., the operator. Needless to say, an object, such as an autonomously driving (driverless) vehicle, can also be fitted with an object transponder in order to protect said vehicle from a collision, for example.

The safety zone is a virtual protection zone via which it can be ensured that in the event of an intervention into the zone a protection mechanism is activated, for example, because the intervening object, such as a robot arm, is immediately stopped. In other words, the protection radius of the safety zone describes that minimum radius in which the transponder is located with certainty, i.e., is reliably not located outside thereof.

This enables, for example, large-scale plants without protective fences to be realized in which dangerous machines are automatically shut down if a worker equipped with an object transponder approaches so closely to the machine that the protection radius overlaps the hazardous area. This is favorable because only that part of the plant containing the machine concerned and not the entire plant is affected by the safety measure.

A computing unit (F-CPU) operating in a failsafe manner as a safety-certified component performs the same computing operations in each case, for example, via two independent computing devices, compares their results with one another and, assuming there is a match, provides a result that is deemed safe. A computing unit operating in a failsafe manner can run safety-related and non-safety-related application programs and is certified up to SIL3 according to IEC standard 61508 and Cat4 PLd according to International Organization for Standardization (ISO) standard 13849-1.

IEC 61508 is an international series of standards for the development of electrical, electronic and programmable electronic systems which perform a safety function. It is published by the International Electrotechnical Commission (IEC) and is titled “Functional Safety of Electrical/Electronic/Programmable Electronic Safety-related Systems”.

The EN ISO 13849 standard is a safety-specific standard which deals with design principles pertaining to safety-related parts of control systems.

The foregoing and other objects and advantages are achieved in accordance with the invention by a method which includes:
a) detecting transmission and reception timestamps for each communication message via a transponder and at least one anchor gateway,
b) transmitting each of the timestamps from the transponder and the at least one anchor gateway together with at least one piece of respective timestamp monitoring information to a failsafe computing device, where the timestamp monitoring information is preferably a piece of parity information
c) implementing at least one check via the failsafe computing device, selected from the following:
   c1) checking the correctness of the respective timestamps based on the at least one piece of timestamp monitoring information,
   c2) checking the calculated duration for the processing times of the transponder and that of the at least one anchor gateway based on known empirical values, and
d) determining the definite safe distance via the failsafe computing device with the aid of the checked timestamps,

where timestamp errors occurring during the detection of the timestamps are caused solely by the transponder or alternatively solely by the anchor gateway.

What is achieved thereby is that the distance to be determined is calculated in a failsafe manner because each computing operation for determining the distance is performed in a computing device operating in a failsafe manner. The acquisition of the basic data, i.e., the timestamps, is accomplished by the transponder or the anchor gateways and the security of the transmission of the timestamps is assured via a piece of respective timestamp monitoring information. For example, an error during the generation, transmission and calculation can therefore be identified and a warning output that the reliability of a completed calculation is currently not ensured.

Only the combination of the use of a failsafe computing device and the corresponding choice of a point in the system at which such a failsafe computing device is to find application, as well as, in this context, the use of suitable timestamps, permits a reliable position determination for application in personal protection systems.

Whereas similar systems necessitate, for example, a complicated temporal synchronization of the components, this can be dispensed with in accordance with the invention because the disclosed method achieves a safe and reliable position determination as a result of the favorable arrangement of the failsafe computing device and the appropriate choice of timestamps.

In an embodiment of the invention, an indicator value for a definite safe distance measurement is determined via the failsafe computing device based on the following relationship, which is a measure for the reliability of the calculated definite safe distance:

$$safe \_ twr \_ value = \frac{( {T}_{R o u n d 1} - {T}_{GW \_ REPLY} - ( {T}_{Round 2} - {T}_{TAG REPLY} )}{2}$$

where

T_{Round1}=2·TOF₂+T_{GW_REPLY}

T_{Round2}=2·TOF₂+T_{TAG_REPLY}

T_{GW_REPLY}=T_{SGW_TX_RESP}−T_{SGW_RX_POLL}

T_{TAG_REPLY}=T_{STAG_TX_FINAL}−T_{STAG_RX_RESP}

and TOF₁ or TOF₂ is the respective signal propagation delay between the transponder and one of the at least two anchor gateways. In this way, it become easy to establish that the generation of the timestamps has occurred in a plausible manner.

In another embodiment of the invention, a poll message, a response message and a final message are sent and received during the wireless communication between the object transponder and the at least one anchor gateway for a localization poll. The method can thus build on a simple and well-known method for two-way measurement.

In a further embodiment of the invention, a transaction number is generated by the failsafe computing device and transmitted together with the response message.

In another embodiment of the invention, the transaction number is a random number. Security against manipulation is increased as a result because knowledge of the number is necessary in order to be able to assign the number to an anchor gateway.

In a further embodiment of the invention, the timestamp monitoring information is a piece of parity information. As a result, a technically simple implementation is achieved in which errors or manipulations during the transmission of the timestamps can be detected without any need to manipulate the timestamps themselves, as could occur, for example, in the case of an encryption and which is at variance with the method in accordance with the invention, namely that calculations are performed only by a failsafe computing device.

In another embodiment of the invention, a communication address of the object transponder or of the at least one anchor gateway is taken into account in the calculation of the monitoring information. This measure further increases the security against manipulation since an additional check can be conducted on the anchor gateways known in the system.

In an embodiment of the invention, definite safe distances are determined in each case at a first and a second point in time, from which distances a movement speed of the transponder is calculated, and the movement speed is compared with a predefined limit value. A further plausibility check on the distance measurements is achieved as a result and the reliability of the method is increased further.

It is also an object of the invention to provide a device that is configured to implement the method in accordance with the disclosed embodiments of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below with reference to exemplary embodiments illustrated in the attached drawings, in which:

FIG. 1 shows an exemplary embodiment of a warning and protection system in accordance with the invention;

FIG. 2 shows an exemplary flowchart for definite safe determination of the distance in accordance with the invention;

FIG. 3 shows an exemplary poll message in accordance with the prior art;

FIG. 4 shows an exemplary TWR response message in accordance with the prior art;

FIG. 5 shows an exemplary response message in accordance with the invention;

FIG. 6 shows an exemplary TWR final message in accordance with the invention; and

FIG. 7 shows an exemplary final message in accordance with the invention.

### DETAILED DESCRIPTION OF THE EXEMPLARY EMBODIMENTS

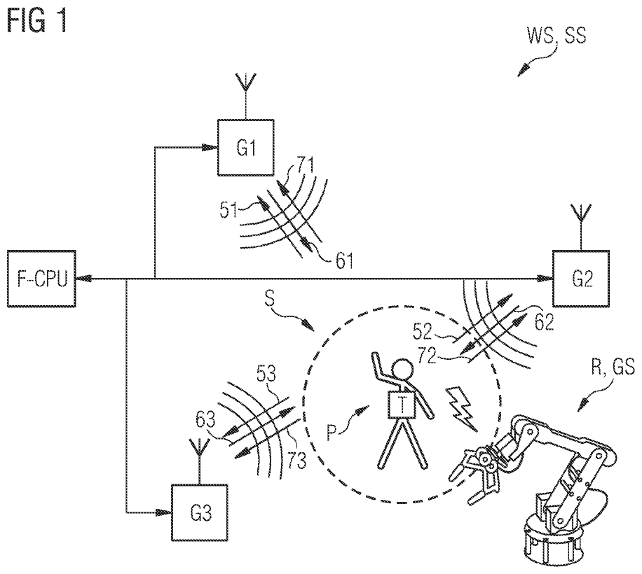

FIG. 1 shows an exemplary embodiment of a warning and protection system.

A respective poll signal P1-P3 that comprises a poll message MP (“Poll”) is transmitted into a radio channel by an object transponder or “tag” T, which is worn on the body of a person P, for example.

The respective poll signal P1-P3 is received from the radio channel by the respective gateway G1-G3, processed further and retransmitted as a respective response signal R1-R3 that comprises a respective response message MR (“Response”).

The response signals R1-R3 are received by the object transponder T, processed further and retransmitted into the radio channel as a respective final signal F1-F3 which comprises the respective final message MF (“Final”).

The final signals F1-F3 are received by the respective gateway G1-G3 and transferred to a computing device F-CPU operating in a failsafe manner, which determines the protection radius r_{P} of a safety zone S.

When a hazard system, for example, in the form of a production plant, is in operation and during this time a robot arm R of the production plant encroaches into the safety zone S, an abort action is triggered to cause the robot arm to halt its operation, as a result of which the robot arm instantly comes to a stop.

The intervention into the safety zone S may occur, for example, as a result of the person P approaching the robot arm R impermissibly closely, and personal protection is no longer reliably ensured.

A method according to the TWR principle that is intended for determining a definite safe distance d_{TWR} between a wirelessly communicating object transponder T and at least one anchor gateway G1-G3, each of which having detectors for detecting timestamps, is described below with reference to an exemplary embodiment of the invention.

Generally, the following steps are performed during the method:
a) detecting transmission and reception timestamps T_{STAG_TX_POLL}, T_{SGW_RX_POLL}, T_{SGW_TX_RESP}, T_{STAG_RX_RESP}, T_{STAG_TX_FINAL}, T_{SGW_RX_FINAL} for each communication message via the transponder T and the at least one anchor gateway G1-G3,
b) transmitting each of the timestamps T_{STAG_TX_POLL}, T_{SGW_RX_POLL}, T_{SGW_TX_RESP}, T_{STAG_RX_RESP}, T_{STAG_TX_FINAL}, T_{SGW_RX_FINAL} from the transponder T and the at least one anchor gateway G1-G3 together with at least one piece of respective timestamp monitoring information CRC1, CRC2, for example, a piece of parity information, to a failsafe computing device F-CPU,
c) implementing at least one check via the failsafe computing device (F-CPU), selected from the following:
   c1) checking the correctness of the respective timestamps T_{STAG_TX_POLL}, T_{SGW_RX_POLL}, T_{SGW_TX_RESP}, T_{STAG_RX_RESP}, T_{STAG_TX_FINAL} T_{SGW_RX_FINAL} based on the at least one piece of timestamp monitoring information CRC1, CRC2, and
   c2) checking the calculated duration for the processing times of the transponder T and that of the at least one anchor gateway G1-G3 based on known empirical values, and
d) determining the definite safe distance d_{TWR} via the failsafe computing device F-CPU with the aid of the checked timestamps T_{STAG_TX_POLL}, T_{SGW_RX_POLL}, T_{SGW_TX_RESP}, T_{STAG_RX_RESP}, T_{STAG_TX_FINAL}, T_{SGW_RX_FINAL},

where timestamp errors occurring during the detection of the timestamps T_{STAG_TX_POLL}, T_{SGW_RX_POLL}, T_{SGW_TX_RESP}, T_{STAG_RX_RESP}, T_{STAG_TX_FINAL}, T_{SGW_RX_FINAL} are caused solely by the transponder T or alternatively solely by the at least one anchor gateway G1-G3.

From this, an indicator value safe_twr_value for a definite safe distance measurement can be determined via the failsafe computing device F-CPU based on the following relationship, which is a measure for the reliability of the calculated definite safe distance d_{TWR}:

$$safe \_ twr \_ value = \frac{( {T}_{R o u n d 1} - {T}_{GW \_ REPLY} ) - ( {T}_{Round 2} - {T}_{TAG \_ REPLY} )}{2}$$

where

T_{Round1}=2·TOF₁+T_{GW_REPLY}

T_{Round2}=2·TOF₂+T_{TAG_REPLY}

T_{GW_REPLY}=T_{SGW_TX_RESP}−T_{SGW_RX_POLL}

T_{TAG_REPLY}=T_{STAG_TX_FINAL}−T_{STAG_RX_RESP}

and TOF₁ or TOF₂ is the respective signal propagation delay between the transponder T and one of the at least two anchor gateways G1-G3.

During the wireless communication, a poll message, a response message and a final message MP, MR, MF are sent and received between the object transponder T and the at least one anchor gateway G1-G3 for a localization poll.

Furthermore, a transaction number RNR can be generated by the failsafe computing device F-CPU and transmitted together with the response message MR. The transaction number RNR is a random number, for example.

An address of the object transponder T or of the at least one anchor gateway G1-G3 can also be taken into account in the calculation of the timestamp monitoring information CRC1, CRC2.

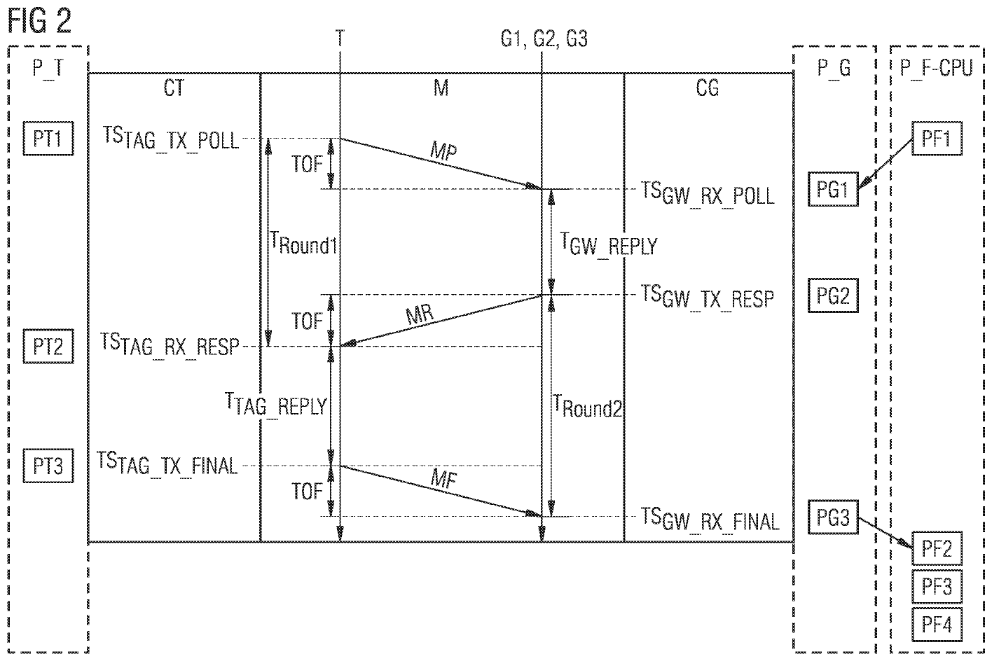

FIG. 2 shows an example of a flowchart for determining the definite safe distance d_{TWR}, with reference to which the invention is described in detail.

A definite safe distance is a true distance that is determined without systemic errors during a time-of-flight measurement.

Undesirable effects, caused, for example, by a fluctuating or inaccurate time base, which can occur during a time-of-flight measurement of signals, are systemically excluded by a corresponding definite “safe” calculation.

The position of the object transponder T (also known as a “tag”) in a three-dimensional space is to be determined in accordance with the statements presented hereinafter, where reference is made to the anchor or gateway transponders G1, G2, G3 at known positions.

The poll message MP is sent at the transponder T or tag at a time having a timestamp T_{STAG_TX_POLL} and received at the respective anchor gateway G1-G3 at a time having a timestamp T_{SGW_RX_POLL}.

The transmission of the poll message MP in the radio channel between the transponder T and the respective gateway of the three gateways G1-G3 requires a duration TOF₁ (“time of flight”).

The poll message MP is processed by the anchor gateway within a time interval T_{GW_REPLY} and a corresponding response message MR from the anchor gateway to the transponder T is sent at a time having a timestamp T_{SGW_TX_RESP} and received at the tag at a time having a timestamp T_{STAG_RX_RESP}.

The time interval T_{GW_REPLY} is determined by the clock pulse of the gateway component T_{GW_CLK} and is known within certain and known limits.

The following can thus be specified:

T_{GW_REPLY}=T_{SGW_TX_RESP}−T_{SGW_RX_POLL}

The time interval T_{Round1} denotes the signal propagation delay between the timestamp T_{STAG_TX_POLL} and the timestamp T_{STAG_RX_RESP}.

T_{Round1}=T_{STAG_RX_RESP}−T_{STAG_TX_POLL}

The transmission in the radio channel requires the duration TOF₂. If the transponder T has not been moved, then TOF₁=TOF₂ applies.

The response message MR is processed by the tag within a time interval T_{TAG_REPLY} and a corresponding final message MF is sent from the anchor gateway to the transponder T at a time having a timestamp T_{STAG_TX_FINAL}.

The time interval T_{TAG_REPLY} is determined by the clock pulse of the gateway component T_{TAG_CLK} and is known within certain and known limits.

The transmission in the radio channel requires the duration TOF₃. If the transponder T has not been moved, then TOF₁=TOF₂=TOF₃ applies.

The anchor gateway receives the final message MF at a time having a timestamp T_{SGW_RX_FINAL}.

The time interval T_{Round2} denotes the signal propagation delay between the timestamp T_{SGW_TX_RESP} and the timestamp T_{SGW_RX_FINAL}.

T_{Round2}=T_{SGW_RX_FINAL}−T_{SGW_TX_RESP}

The following can thus be specified:

T_{TAG_REPLY}=T_{STAG_TX_FINAL}−T_{STAG_RX_RESP}

The timestamps are detected by a tag counter CT in the object transponder or by a gateway counter CG in the anchor transponder.

The signal propagation delay in the radio channel can be determined from the calculated times of flight TOF=TOF₁=TOF₂=TOF₃ and the corresponding distance d_{TWR} via the speed of light c.

$$TOF = \frac{{T}_{R o u n d 1} . {T}_{R o u n d 2} - {T}_{G {W}_{R E P L Y}} . {T}_{TAG \_ REPLY}}{{T}_{R o u n d 1} + {T}_{R o u n d 2} + {T}_{{GW}_{REPLY}} + {T}_{TAG \_ REPLY}} \\ {d}_{TWR} = c \cdot TOF$$

The computing device F-CPU can now detect a first error if the timestamps of the transponder and the gateways required for calculating the distance are falsified.

It is assumed in this case that only errors on the part of the transponder T or alternatively only errors on the part of one of the gateways G1-G3 happen at the same time, and not errors on the part of the transponder and a gateway simultaneously.

A systemic error is understood to mean an error that adversely affects the generation or detection of timestamps, for example, an undesirably deviating time base in an electronic component, which may be caused by changing temperature, aging, component tolerances or similar. Such an error can occur between individual components in a system, such as the transponder T and a gateway G1-G3, because a local time base in the form of a clock generation for a digital electronics circuit changes erratically.

Timestamps or a drift of a respective timer clock pulse in a component, such as the transponder T1 or the gateways G1-G3, are independent of one another. Consequently, an error affects only the timestamp of the component in question and not those of the other components.

TWR features integrated error detection. This is based on the following relationships:

T_{Round1}=2·TOF₁+T_{GW_REPLY}

T_{Round2}=2·TOF₂+T_{TAG_REPLY}

A deviation from TOF, i.e., the difference between TOF₁ and TOF₂ due to errors in the transponder or in the gateway, can now be calculated by the relationship

$$safe \_ twr \_ value = \frac{( {T}_{R o u n d 1} - {T}_{GW \_ REPLY} ) - ( {T}_{Round 2} - {T}_{TAG REPLY} )}{2}$$

A TWR result is valid for safe_{twrvalue}<safe_twr_value_limit at safe_twr_value_limit=825 ps, otherwise the result is invalid.

With the value safe_twr_value_limit=825 ps, a clock drift for the transponder is limited at <±200 ppm.

Also shown in the figure in simplified form as part of the flowchart is a program P_T of the transponder T comprising method steps PT1-PT3 for the transponder T.

A program P_G of a respective gateway G1-G3 comprising method steps PG1-PG3 for the respective gateway G1-G3 can also be seen, as well as a program P_F of the failsafe computing device F-CPU comprising method steps PF1-PF4 for the computing device F-CPU.

In step PT1, the poll message MP is initiated by the transponder T and sent.

In step PG1, the respective gateway receives the poll message MP and determines the transmission time point for the response message MR.

In step PF1, a random number RNR is generated by the failsafe computing device F-CPU and sent to the respective gateway.

In step PG2, the gateway sends a response message MR containing the random number RNR to the transponder T.

In step PT2, the response message MR is received by the transponder T and the transmission time point for the final message MF is calculated.

In step PT3, the transponder T determines a first checksum CRC1 from the timestamps and the address of the transponder T, as well as the random number, and sends a final message MF containing the first checksum CRC1 from the transponder T to the gateway.

In step PG3, the gateway receives the final message MF and determines a second checksum CRC2 from the timestamps and the address of the gateway and the first checksum CRC1 and transmits the timestamps and the address of the gateway and of the transponder T, as well as the second checksum CRC2, to the device F-CPU.

In step PF2, the device F-CPU calculates a third checksum CRC3 and compares the third checksum CRC3 with the second checksum CRC2.

In step PF3, the device F-CPU calculates a definite safe value safe_twr_value for the distance between the gateway and the transponder T via the TWR method and submits the values to a plausibility check.

In step PF4, the device F-CPU calculates the desired definite safe distance with the aid of the preceding relationship in respect of the signal propagation delay in the radio channel TOF.

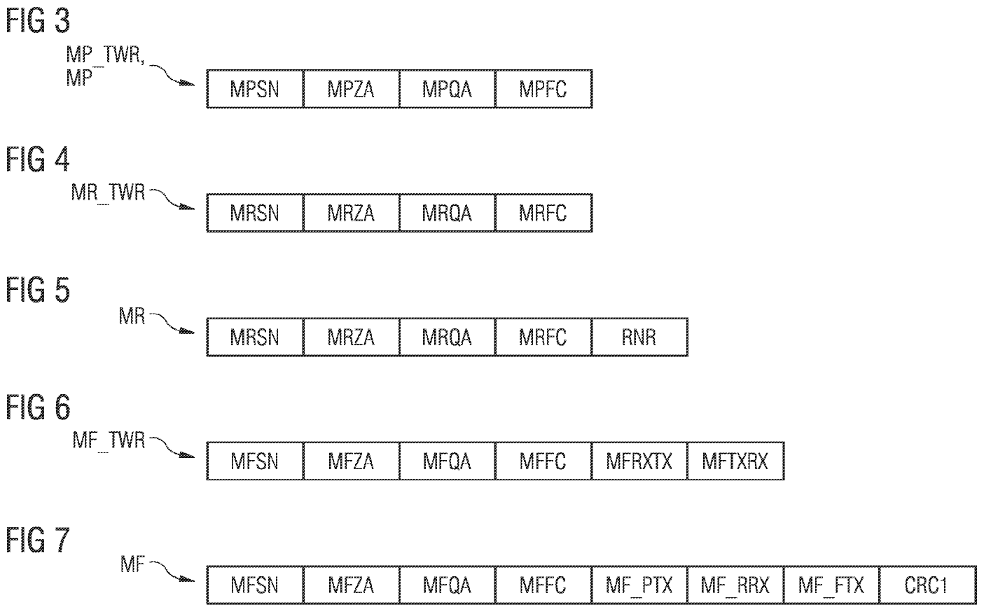

FIG. 3 shows by way of example a poll message MP_TWR in accordance with the prior art for TWR, which comprises data elements for a sequence number MPSN, a destination address MPZA, a source address MPQA and a function code MPFC, and which can also be used, for example, as a poll message MP in the method in accordance with the disclosed embodiments of the invention.

FIG. 4 shows by way of example a response message MR_TWR in accordance with the prior art for TWR, which comprises data elements for a sequence number MRSN, a destination address MRZA, a source address MRQA and a function code MRFC.

FIG. 5 shows by way of example the response message MR in accordance with the invention, which comprises data elements for a sequence number MRSN, a destination address MRZA, a source address MRQA and a function code MRFC. The function code MRFC may be different from that of the prior art.

The random number RNR is included in addition.

FIG. 6 shows by way of example the final message MF in accordance with the prior art for TWR, which comprises data elements for a sequence number MFSN, a destination address MFZA, a source address MFQA and a function code MFFC. The function code MFFC may be different from that of the prior art.

In addition, the final message MF contains a data element for a time difference MFRXTX, which denotes the time elapsed between the transmission of the poll message MP and the reception of the response message MR via the transponder T. The final message MF also includes a data element for a time difference MFTXRX, which denotes the time elapsed between the reception of the response message MR and the transmission of the final message MF via the transponder T.

FIG. 7 shows by way of example the final message MP according to the invention, which comprises data elements for a sequence number MPSN, a destination address MPZA, a source address MPQA and a function code MPFC. The function code MFFC may be different from that of the prior art.

The final message MP further contains a data element in the form of a timestamp in each case for a poll transmission time point MF_PTX, a response reception time point MF_RRX, and a final transmission time point MF_FTX.

The final message MP also contains the first checksum CRC1, which is formed by way of the timestamps of the transponder T and by way of the random number RNR.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A method for determining a definite safe distance (d_{TWR}) between a wirelessly communicating object transponder (T) and at least one anchor gateway (G1-G3), each of which having detectors for detecting timestamps, in accordance with a two-way ranging method, the method comprising:
a) detecting transmission and reception timestamps (T_{STAG_TX_POLL}, T_{SGW_RX_POLL}, T_{SGW_TX_RESP}, T_{STAG_RX_RESP}, T_{STAG_TX_FINAL}, T_{SGW_RX_FINAL}) for each communication message via the transponder (T) and the at least one anchor gateway (G1-G3);
b) transmitting each of the timestamps (T_{STAG_TX_POLL}, T_{SGW_RX_POLL}, T_{SGW_TX_RESP}, T_{STAG_RX_RESP}, T_{STAG_TX_FINAL}, T_{SGW_RX_FINAL}) from the transponder (T) and the at least one anchor gateway (G1-G3) together with at least one respective piece of timestamp monitoring information (CRC1, CRC2) to a failsafe computing device (F-CPU);
c) implementing at least one check via the failsafe computing device (F-CPU), selected from the following:
c1) checking a correctness of respective timestamps (T_{STAG_TX_POLL}, T_{SGW_RX_POLL}, T_{SGW_TX_RESP}, T_{STAG_RX_RESP}, T_{STAG_TX_FINAL}, T_{SGW_RX_FINAL}) based on the at least one piece of timestamp monitoring information (CRC1, CRC2); and
c2) checking the calculated duration for the processing times of the transponder (T) and that of the at least one anchor gateway (G1-G3) based on known empirical values; and
d) determining the definite safe distance (d_{TWR}) via the failsafe computing device (F-CPU) aided by the checked timestamps (T_{STAG_TX_POLL}, T_{SGW_RX_POLL}, T_{SGW_TX_RESP}, T_{STAG_RX_RESP}, T_{STAG_TX_FINAL}, T_{SGW_RX_FINAL}),
wherein timestamp errors occurring during the detection of the timestamps (T_{STAG_TX_POLL}, T_{SGW_RX_POLL}, T_{SGW_TX_RESP}, T_{STAG_RX_RESP}, T_{STAG_TX_FINAL}, T_{SGW_RX_FINAL}) are caused solely by the transponder (T) or alternatively solely by one anchor gateway of the at least two anchor gateways (G1-G3); and
wherein a poll message, a response message and a final message (MP, MR, MF) are sent and received during the wireless communication between the object transponder (T) and the at least one anchor gateway (G1-G3) for a localization poll.

11. The method as claimed in claim 9, wherein an indicator value (safe_twr_value) for a definite safe distance measurement is determined via the failsafe computing device (F-CPU) based on the following relationship, which is a measure for reliability of the calculated definite safe distance (d_{TWR}):
$$safe \_ twr \_ value = \frac{( {T}_{R o u n d 1} - {T}_{GW \_ REPLY} ) - ( {T}_{R o u n d 2} - {T}_{TAG REPLY} )}{2}$$
where
T_{Round1}=2·TOF₁+T_{GW_REPLY}
T_{Round2}=2·TOF₂+T_{TAG_REPLY}
T_{GW_REPLY}=T_{SGW_TX_RESP}−T_{SGW_RX_POLL}
T_{TAG_REPLY}=T_{STAG_TX_FINAL}−T_{STAG_RX_RESP}
and TOF₁ or TOF₂ is the respective signal propagation delay between the transponder (T) and one anchor gateway of the at least two anchor gateways (G1-G3),
and time stamps T_{STAG_TX_POLL}, T_{STAG_RX_RESP}, T_{STAG_TX_FINAL} are detected by the transponder (T), and time stamps T_{SGW_RX_POLL}, T_{SGW_TX_RESP}, T_{SGW_RX_FINAL} are detected by one anchor gateway of the at least two anchor gateways (G1-G3).

12. The method as claimed in claim 9, wherein a transaction number (RNR) is generated by the failsafe computing device (F-CPU) and transmitted by the failsafe computing device (F-CPU) together with the response message (MR) from the at least one anchor gateway (G1-G3) to the object transponder (T).

13. The method as claimed in claim 9, wherein the transaction number (RNR) is a random number.

14. The method as claimed in claim 9, wherein the timestamp monitoring information (CRC1, CRC2) comprises a piece of parity information.

15. The method as claimed in claim 9, wherein a communication address of at least one of the object transponder (T) and the at least one anchor gateway (G1-G3) is taken into account during the calculation of the timestamp monitoring information (CRC1, CRC2).

16. The method as claimed in claim 9, wherein definite safe distances (d_{TWR}) are determined in each case at a first and a second point in time, from which distances a movement speed of the transponder (T) is calculated, and the movement speed is compared with a predefined limit value.

17. A device for determining a definite safe distance (d_{TWR}) between a wirelessly communicating object transponder (T) and at least one anchor gateway (G1-G3), each of which having detectors for detecting timestamps, via a failsafe computing device (F-CPU) in accordance with a two-way ranging method, wherein the device is configured to:
a) detect transmission and reception timestamps (T_{STAG_TX_POLL}, T_{SGW_RX_POLL}, T_{SGW_TX_RESP}, T_{STAG_RX_RESP}, T_{STAG_TX_FINAL}, T_{SGW_RX_FINAL}) for each communication message via the transponder (T) and the at least one anchor gateway (G1-G3),
b) transmit each of the timestamps (T_{STAG_TX_POLL}, T_{SGW_RX_POLL}, T_{SGW_TX_RESP}, T_{STAG_RX_RESP}, T_{STAG_TX_FINAL}, T_{SGW_RX_FINAL}) from the transponder (T) and the at least one anchor gateway (G1-G3) together with at least one respective piece of timestamp monitoring information (CRC1, CRC2) to a failsafe computing device (F-CPU),
c) implement at least one check via the failsafe computing device (F-CPU), selected from the following:
c1) check a correctness of respective timestamps (T_{STAG_TX_POLL}, T_{SGW_RX_POLL}, T_{SGW_TX_RESP}, T_{STAG_RX_RESP}, T_{STAG_TX_FINAL}, T_{SGW_RX_FINAL}) based on the at least one piece of timestamp monitoring information (CRC1, CRC2); and
c2) check the calculated duration for the processing times of the transponder (T) and that of the at least one anchor gateway (G1-G3) based on known empirical values; and
d) determine the definite safe distance (d_{TWR}) via the failsafe computing device (F-CPU) aided by the checked timestamps (T_{STAG_TX_POLL}, T_{SGW_RX_POLL}, T_{SGW_TX_RESP}, T_{STAG_RX_RESP}, T_{STAG_TX_FINAL}, T_{SGW_RX_FINAL}),
wherein timestamp errors occurring during the detection of the timestamps (T_{STAG_TX_POLL}, T_{SGW_RX_POLL}, T_{SGW_TX_RESP}, T_{STAG_RX_RESP}, T_{STAG_TX_FINAL}, T_{SGW_RX_FINAL}) are caused solely by the transponder (T) or alternatively solely by one anchor gateway of the at least two anchor gateways (G1-G3); and
wherein a poll message, a response message and a final message (MP, MR, MF) are sent and received during the wireless communication between the object transponder (T) and the at least one anchor gateway (G1-G3) for a localization poll.
